(19) United States
(12) Patent Application Publication
(10) Pub. No.: US 2025/0264703 A1
(43) Pub. Date: Aug. 21, 2025

(54) ZOOM LENS AND IMAGE PICKUP APPARATUS

(71) Applicant: CANON KABUSHIKI KAISHA, Tokyo (JP)

(72) Inventor: Akihiko YUKI, Saitama (JP)

(21) Appl. No.: 19/039,822

(22) Filed: Jan. 29, 2025

(30) Foreign Application Priority Data
Feb. 20, 2024 (JP) 2024-024017

(51) Int. Cl. G02B 15/20; G02B 15/14

(52) U.S. Cl. CPC G02B 15/20; G02B 15/1461

(57) ABSTRACT

A zoom lens includes, in order from an object side to an image side, a first lens unit with positive refractive power that does not move during zooming, at least two movable lens units that move during zooming, and a final lens unit with positive refractive power that does not move during zooming. A distance between adjacent lens units changes during zooming. The first lens unit includes at least one negative lens and at least one positive lens. A predetermined inequality is satisfied.

### BACKGROUND

### Technical Field

The disclosure relates to a zoom lens suitable for imaging.

### Description of Related Art

Zoom lenses are demanded to have a reduced size, a wide angle of view, a high magnification variation ratio, high optical performance, and uniform resolution from the center to the periphery of the imaging angle of view.

As zoom lenses having a reduced size, a wide angle of view, and a high magnification variation ratio, Japanese Patent Laid-Open No. 2018-120152 and PCT International Patent Publication No. WO2017/130478 disclose positive lead type zoom lenses that include, in order from the object side to the image side, a first lens unit with positive refractive power that does not move during zooming, at least two movable lens units that move during zooming, and a final lens unit with positive refractive power that does not move during zooming. These zoom lenses are of an inner focus type in which a focus lens unit in the first lens unit is moved during focusing.

### SUMMARY

A zoom lens according to one aspect of the disclosure includes, in order from an object side to an image side, a first lens unit with positive refractive power that does not move during zooming, at least two movable lens units that move during zooming, and a final lens unit with positive refractive power that does not move during zooming. A distance between adjacent lens units changes during zooming. The first lens unit includes at least one negative lens and at least one positive lens. The following inequality is satisfied:

10.0≤νp1≤17.4

where νp1 is an Abbe number based on d-line of a first positive lens included in the at least one positive lens. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1 in an in-focus state at infinity at a wide-angle end.

FIG. 2A is an aberration diagram of the zoom lens according to Example 1 in the in-focus state at infinity at the wide-angle end, FIG. 2B is an aberration diagram of the zoom lens according to Example 1 in the in-focus state at infinity at an intermediate zoom position, and FIG. 2C illustrates an aberration diagram of the zoom lens according to Example 1 in the in-focus state at infinity at a telephoto end.

FIG. 3 is a sectional view of a zoom lens according to Example 2 in an in-focus state at infinity at a wide-angle end.

FIG. 4A is an aberration diagram of the zoom lens according to Example 2 in the in-focus state at infinity at the wide-angle end, FIG. 4B is an aberration diagram of the zoom lens according to Example 2 in the in-focus state at infinity at an intermediate zoom position, and FIG. 4C is an aberration diagram of the zoom lens according to Example 2 in the in-focus state at infinity at a telephoto end.

FIG. 5 is a sectional view of a zoom lens according to Example 3 in an in-focus state at infinity at a wide-angle end.

FIG. 6A is an aberration diagram of the zoom lens according to Example 3 in the in-focus state at infinity at the wide-angle end, FIG. 6B is an aberration diagram of the zoom lens according to Example 3 in the in-focus state at infinity at an intermediate zoom position, and FIG. 6C is an aberration diagram of the zoom lens according to Example 3 in the in-focus state at infinity at a telephoto end.

FIG. 7 is a sectional view of a zoom lens according to Example 4 in an in-focus state at infinity at a wide-angle end.

FIG. 8A is an aberration diagram of the zoom lens according to Example 4 in the in-focus state at infinity at the wide-angle end, FIG. 8B is an aberration diagram of the zoom lens according to Example 4 in the in-focus state at infinity at an intermediate zoom position, and FIG. 8C is an aberration diagram of the zoom lens according to Example 4 in the in-focus state at infinity at a telephoto end.

FIG. 9 is a sectional view of a zoom lens according to Example 5 in an in-focus state at infinity at a wide-angle end.

FIG. 10A is an aberration diagram of the zoom lens according to Example 5 in the in-focus state at infinity at the wide-angle end, FIG. 10B is an aberration diagram of the zoom lens according to Example 5 in the in-focus state at infinity at an intermediate zoom position, and FIG. 10C is an aberration diagram of the zoom lens according to Example 5 in the in-focus state at infinity at a telephoto end.

FIG. 11 is a sectional view of a zoom lens according to Example 6 in an in-focus state at infinity at a wide-angle end.

FIG. 12A is an aberration diagram of the zoom lens according to Example 6 in the in-focus state at infinity at the wide-angle end, FIG. 12B is an aberration diagram of the zoom lens according to Example 6 in the in-focus state at infinity at an intermediate zoom position, and FIG. 12C is an aberration diagram of the zoom lens according to Example 6 in the in-focus state at infinity at a telephoto end.

FIG. 13 is a schematic diagram of an image pickup apparatus having a zoom lens according to any one of Examples 1 to 6.

### DETAILED DESCRIPTION

Referring now to the accompanying drawings, a description will be given of embodiments according to the disclosure.

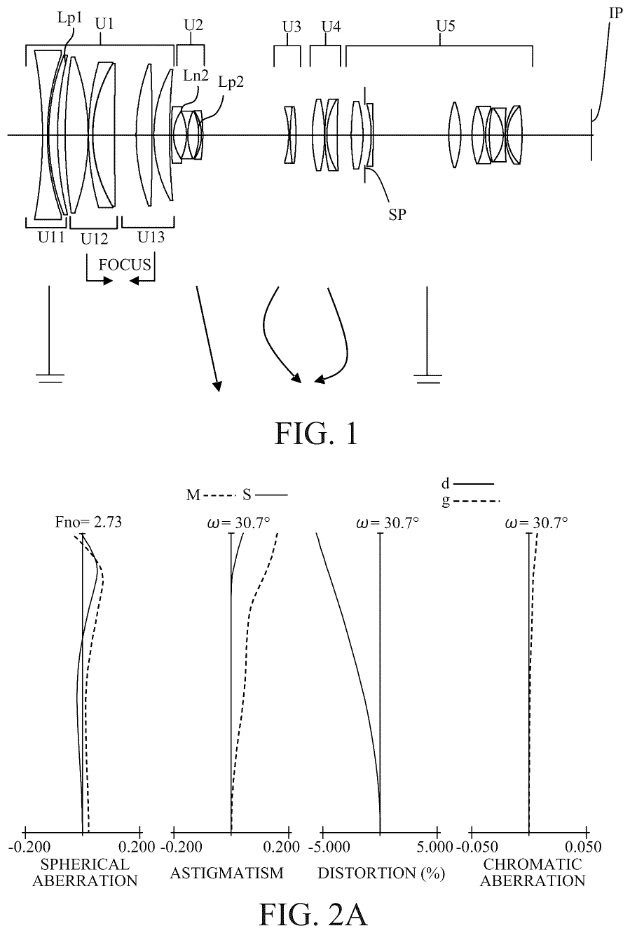

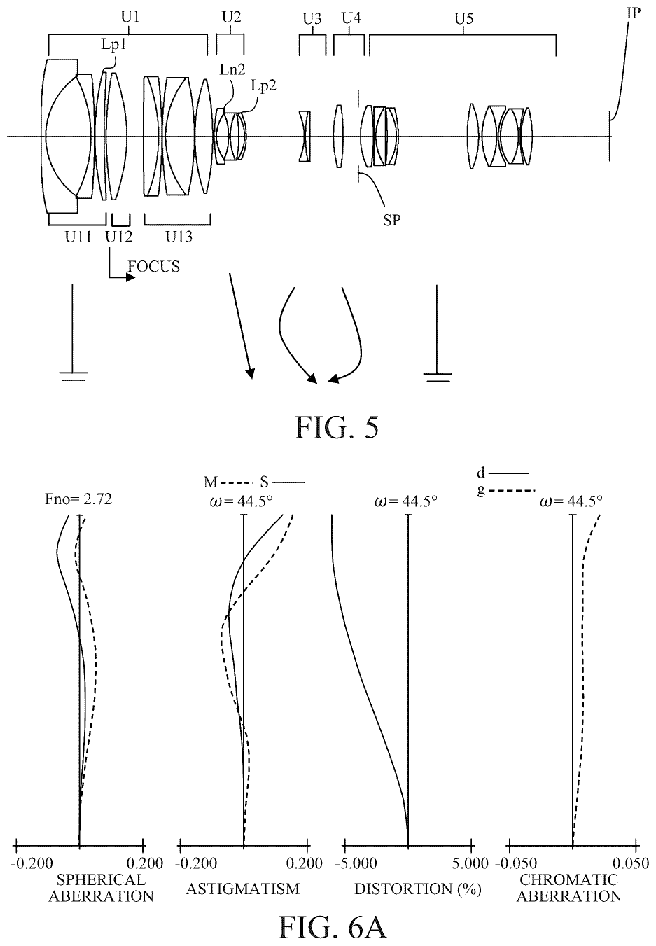

FIGS. 1, 3, 5, 7, 9, and 11 illustrate sections of zoom lenses according to Examples 1 to 6 in a state where the optical system is in focus on an object at infinity (referred to as “in an in-focus state at infinity” hereinafter) at a wide-angle end. In each sectional view, a left side is an object side (front side) and a right side is an image side (rear side).

Before Examples 1 to 6 are specifically described, a description will now be given of matters common to each example. The zoom lens according to each example is used in various image pickup apparatuses such as broadcasting cameras, cinema cameras, video cameras, security cameras, digital still cameras, and film-based cameras.

The zoom lens according to each example includes, in order from the object side to the image side, a first lens unit U1 with positive refractive power that does not move during zooming, at least two movable lens units Um (m=2 to 5) that move during zooming, and a final lens unit Ur (r=5 or 6) with positive refractive power that does not move during zooming.

In a zoom lens, a lens unit is a group of one or more lenses that may or may not integrally move during zooming (magnification variation) between a wide-angle end and a telephoto end. That is, a distance between adjacent lens units changes during zooming. The lens unit may include an aperture stop (diaphragm). The wide-angle end and the telephoto end respectively indicate zoom states of the maximum angle of view (shortest focal length) and the minimum angle of view (longest focal length) in a case where the lens unit that moves during zooming is located at both ends of a mechanically or controllably movable range on the optical axis.

SP represents an aperture stop. IP represents an image plane. An imaging surface (light receiving surface) of an image sensor such as a CCD sensor or a CMOS sensor, or the film surface (photosensitive surface) of a silver film is disposed on the image plane IP.

In the zoom lens according to each example, the first lens unit U1, which has the maximum weight, is fixed during zooming, thereby suppressing changes in the center of gravity of the zoom lens along with zooming. The first lens unit U1 with positive refractive power can mainly suppress the diameter of a light beam incident on the second lens unit U2 at the telephoto end. Thereby, the size of each movable lens unit that moves during zooming can be reduced.

In the zoom lens according to each example, the final lens unit Ur that is fixed during zooming can provide a mechanism for adjusting the flange back by moving the final lens unit Ur.

In the zoom lens according to each example, the first lens unit U1 may include at least one negative lens and at least one positive lens. In that case, the following inequality may be satisfied:

$$10. \leq vp 1 \leq 17.4 \qquad ( 1 )$$

where νp1 is an Abbe number of the first positive lens Lp1 included in the at least one positive lens based on the d-line.

The first lens unit U1 may include at least one negative lens and at least one positive lens, and the Abbe number νp1 of the material for the first positive lens Lp1 may be set to satisfy inequality (1). This configuration can satisfactorily correct zoom fluctuations in lateral chromatic aberration in a case where the angle of view of the zoom lens is increased by increasing the refractive power of the negative lens. In a case where νp1 becomes higher than the upper limit of inequality (1), the material of the first positive lens Lp1 becomes a low-dispersion material with an excessively large Abbe number, and it becomes difficult to correct (achromatize) the chromatic aberration generated in the negative lens with the first positive lens Lp1. As a result, the lateral chromatic aberration over the entire zoom range cannot be suppressed. In a case where νp1 becomes lower than the lower limit of inequality (1), the Abbe number of the first positive lens Lp1 reduces and the refractive power of the first positive lens reduces in correcting the chromatic aberration generated in the negative lens with the first positive lens Lp1, and it becomes difficult to correct spherical aberration at the telephoto end.

Inequality (1) may be replaced with inequality (1a) below:

$$12. \leq vp 1 \leq 17.2 \qquad ( 1 a )$$

Inequality (1) may be replaced with inequality (1b) below:

$$14. \leq vp 1 \leq 17.1 \qquad ( 1 b )$$

Satisfying the above configurations and inequality can achieve a zoom lens that has a reduced size, a wide angle of view, a high magnification variation ratio, and high optical performance over the entire zoom range.

The zoom lens according to each example may satisfy at least one of the following inequalities (2) to (12) and configurations.

The zoom lens according to each example may satisfy the following inequality (2):

$$1.95 \leq Np 1 \leq 2.35 \qquad ( 2 )$$

where Np1 is a refractive index of the first positive lens Lp1 for the d-line.

In a case where Np1 becomes lower than the lower limit of inequality (2), the refractive index of the first positive lens Lp1 reduces, and it becomes difficult to correct the image height variation of lateral chromatic aberration at the wide-angle end. In a case where Np1 becomes higher than the upper limit of inequality (2), the partial dispersion ratio of the first positive lens Lp1 for the g-line and F-line becomes too large for the existing materials, it becomes difficult to correct the secondary spectrum of lateral chromatic aberration at the wide-angle end.

Inequality (2) may be replaced with inequality (2a) below:

$$1.96 \leq Np 1 \leq 2.25 \qquad ( 2 a )$$

Inequality (2) may be replaced with inequality (2b) below:

$$1.97 \leq Np 1 \leq 2.22 \qquad ( 2 b )$$

In the zoom lens according to each example, the first lens unit U1 may include, in order from the object side to the image side, a first subunit U11 with negative refractive power, a second subunit U12 with positive refractive power, and a third subunit U13 with positive refractive power. During focusing, the first subunit U11 does not move, and at least the second subunit U12 among the second subunit U12 and the third subunit U13 moves. The first lens unit U1 thus configured can increase an angle of view of the zoom lens, reduce a moving amount of the subunit that moves during focusing, and suppress changes in the angle of view (breathing) and aberration fluctuations associated with the movement of the subunit during focusing.

In the zoom lens according to each example, the first subunit U11 with negative refractive power may include at least one negative lens and the first positive lens Lp1. In this case, the following inequalities (3) and (4) may be satisfied:

$$5 \leq vn {1}_{ave} - vp 1 \leq 40 \qquad ( 3 )$$

$$- 0. 065 \leq ( θ n {1}_{ave} - θ p 1 ) / ( vn {1}_{ave} - vp 1 ) \leq - 0.0025 \qquad ( 4 )$$

where νn1ₐᵥₑ is an average Abbe number based on the d-line of the at least one negative lens, θn1ₐᵥₑ is an average partial dispersion ratio for the g-line and the F-line of the at least one negative lens, and θp1 is a partial dispersion ratio for the g-line and the F-line of the first positive lens Lp1.

Inequality (3) defines a proper relationship of the Abbe number for achromatization in the first subunit U11. In a case where νn1ₐᵥₑ−νp1 becomes higher than the upper limit of inequality (3), a difference in Abbe number between the negative lens and the first positive lens Lp1 in the first subunit U11 increases, it becomes difficult to achieve both achromatization of the first subunit U11 and aberration correction for the reference wavelength (d-line), and it becomes difficult to suppress spherical aberration at the telephoto end. In a case where νn1ₐᵥₑ−νp1 becomes lower than the lower limit of inequality (3), the difference in Abbe number between the negative lens and the first positive lens Lp1 in the first subunit U11 reduces, it becomes difficult to achromatize the first subunit U11, and lateral chromatic aberration throughout the entire zoom range cannot be suppressed.

Inequality (4) defines a proper relationship between the partial dispersion ratios for correcting the secondary spectrum of chromatic aberration in the first subunit U11. In a case where (θn1ₐᵥₑ−θp1)/(νn1ₐᵥₑ−νp1) becomes higher than the upper limit of inequality (4), a difference in partial dispersion ratio between the negative lens and the first positive lens Lp1 in the first subunit U11 increases. As a result, the secondary spectrum of lateral chromatic aberration is undercorrected, particularly at the wide-angle end. In a case where (θn1ₐᵥₑ−θp1)/(νn1ₐᵥₑ−νp1) becomes lower than the lower limit of inequality (4), the difference in partial dispersion ratio between the negative lens and the first positive lens Lp1 in the first subunit U11 reduces. This results in overcorrection of the secondary spectrum of longitudinal chromatic aberration, particularly at the telephoto end.

Inequalities (3) and (4) may be replaced with inequalities (3a) and (4a) below:

$$8 \leq vn {1}_{ave} - vp 1 \leq 37 \qquad ( 3 a )$$

$$- 0. 062 \leq ( θ n {1}_{ave} - θ p 1 ) / ( vn {1}_{ave} - vp 1 ) \leq - 0.0027 \qquad ( 4 a )$$

Inequalities (3) and (4) may be replaced with inequalities (3b) and (4b) below:

$$9 \leq vn {1}_{ave} - vp 1 \leq 35 \qquad ( 3 b )$$

$$- 0. 060 \leq ( θ n {1}_{ave} - θ p 1 ) / ( vn {1}_{ave} - vp 1 ) \leq - 0.0030 \qquad ( 4 b )$$

The zoom lens according to each example may satisfy at least one of the following inequalities (5) and (6):

$$0.4 \leq fn 1 / f 11 \leq 2. \qquad ( 5 )$$

$$- 6. 0 \leq fp 1 / f 11 \leq - 0.60 \qquad ( 6 )$$

where fn1 is a focal length of the negative lens Ln1 closest to the object among at least one negative lens in the first subunit U11, fp1 is a focal length of the first positive lens Lp1, and f11 is a focal length of the first subunit U11.

Inequality (5) defines a proper relationship between the focal length of the negative lens closest to the object in the first subunit U11 and the focal length of the first subunit U11. In a case where fn1/f11 becomes higher than the upper limit of inequality (5), the refractive power of the negative lens closest to the object reduces, and it becomes difficult to achieve a wide angle of view for the zoom lens. In a case where fn1/f11 becomes lower than the lower limit of inequality (5), the refractive power of the negative lens closest to the object increases, and it becomes difficult to correct the zoom fluctuations of lateral chromatic aberration.

Inequality (6) defines a proper relationship between the focal length of the first positive lens Lp1 in the first subunit U11 and the focal length of the first subunit U11. In a case where fp1/f11 becomes higher than the upper limit of inequality (6), the refractive power of the first positive lens Lp1 reduces, and it becomes difficult to correct the chromatic aberration of the first subunit U11. In a case where fp1/f11 becomes lower than the lower limit of inequality (6), the refractive power of the first positive lens Lp1 increases, and it becomes difficult to correct spherical aberration, particularly at the telephoto end.

Inequalities (5) and (6) may be replaced with inequalities (5a) and (6a) below:

$$0.43 \leq fn 1 / f 11 \leq 1.65 \qquad ( 5 a )$$

$$- 5.5 \leq fp 1 / f 11 \leq - 0.70 \qquad ( 6 a )$$

Inequalities (5) and (6) may be replaced with inequalities (5b) and (6b) below:

$$0.45 \leq fn 1 / f 11 \leq 1.4 \qquad ( 5 b )$$

$$- 4.9 \leq fp 1 / f 11 \leq - 0.85 \qquad ( 6 b )$$

The zoom lens according to each example may satisfy the following inequality (7):

$$2.5 \leq ft / f 1 \leq 5. \qquad ( 7 )$$

where f1 is a focal length of the first lens unit U1, and ft is a focal length of the zoom lens at the telephoto end.

Inequality (7) defines a proper relationship between the focal length of the first lens unit U1 and the focal length of the zoom lens at the telephoto end. In a case where ft/f1 becomes lower than the lower limit of inequality (7), the focal length of the first lens unit U1 increases, the overall length of the zoom lens having high magnification variation increases, and the size reduction becomes difficult. In a case where ft/f1 becomes higher than the upper limit of inequality (7), the focal length of the first lens unit U1 reduces, and it becomes difficult to correct lateral chromatic aberration at the telephoto end.

Inequality (7) may be replaced with inequality (7a) below:

$$2.55 \leq ft / f 1 \leq 4.5 \qquad ( 7 a )$$

Inequality (7) may be replaced with inequality (7b) below:

$$2.6 \leq ft / f 1 \leq 4. \qquad ( 7 b )$$

In the zoom lens according to each example, at least one of at least two movable lens units that move during zooming may have negative refractive power, and the following inequality (8) may be satisfied:

$$1. 0 \leq \vert f 1 / f 2 \vert \leq 6. 0 \qquad ( 8 )$$

where f2 is a focal length closest to the object of a movable lens unit in the movable lens unit with negative refractive power.

Inequality (8) defines a proper relationship between the focal length of the negative movable lens unit closest to the object and the focal length of the first lens unit U1. In a case where |f1/f2| becomes lower than the lower limit of inequality (8), the refractive power of the negative movable lens unit closest to the object becomes much lower than the refractive power of the first lens unit, and a moving amount of the negative movable lens unit closest to the object during zooming increases. As a result, the overall length of the zoom lens increases, and the size reduction becomes difficult. In a case where |f1/f2| becomes higher than the upper limit of inequality (8), the refractive power of the negative movable lens unit closest to the object becomes much higher than the refractive power of the first lens unit, and the aberration fluctuation associated with zooming increases.

Inequality (8) may be replaced with inequality (8a) below:

$$1.2 \leq \vert f 1 / f 2 \vert \leq 5. 8 \qquad ( 8 a )$$

Inequality (8) may be replaced with inequality (8b) below:

$$1.3 \leq \vert f 1 / f 2 \vert \leq 5.7 \qquad ( 8 b )$$

In the zoom lens according to each example, the negative movable lens unit closest to the object described above may have a negative lens Ln2 and a second positive lens Lp2, and the following inequalities (9) and (10) may be satisfied:

$$60 \leq vn 2 \leq 105 \qquad ( 9 )$$

$$- 0. 02 \leq θ n 2 + 0.0 \; 01 \times vn 2 - 0.603 \leq 0.050 \qquad ( 10 )$$

where νn2 is an Abbe number based on the d-line of the negative lens Ln2, and θn2 is a partial dispersion ratio for the g-line and F-line of the negative lens Ln2.

In addition, the following inequalities (11) and (12) may be satisfied:

$$20 \leq vp 2 \leq 40 \qquad ( 11 )$$

$$0.648 \leq θ p 2 + 0.00253 \times vp 2 \leq 0.68 \qquad ( 12 )$$

where νp2 is an Abbe number based on the d-line of the second positive lens Lp2, and θp2 is a partial dispersion ratio for the g-line and F-line of the second positive lens Lp2.

Inequalities (9) and (10) define proper relationships of the Abbe number and the partial dispersion ratio of the negative lens Ln2 included in the negative movable lens unit closest to the object. In a case where νn2 becomes higher than the upper limit of inequality (9), the refractive index of the negative lens Ln2 becomes too small for the existing materials, and it becomes difficult to suppress the fluctuations in curvature of field over the entire zoom range. In a case where νn2 becomes lower than the lower limit of inequality (9), the material of the negative lens Ln2 becomes a high-dispersion material with a too small Abbe number, it becomes difficult to correct chromatic aberration in the negative moving lens unit closest to the object, and it becomes difficult to suppress the fluctuations in lateral chromatic aberration throughout the entire zoom range.

In a case where θn2+0.001×νn2−0.603 becomes higher than the upper limit of inequality (10), the partial dispersion ratio of the negative lens Ln2 increases, and it becomes difficult to correct the secondary spectrum of the longitudinal chromatic aberration, especially at the telephoto end. In a case where θn2+0.001×νn2−0.603 becomes lower than the lower limit of inequality (10), the partial dispersion ratio of the negative lens Ln2 reduces, and the secondary spectrum of lateral chromatic aberration at the wide-angle end is undercorrected.

Inequalities (11) and (12) define proper relationships of the Abbe number and the partial dispersion ratio of the second positive lens Lp2 included in the negative movable lens unit closest to the object. In a case where νp2 becomes higher than the upper limit of inequality (11), the material of the second positive lens Lp2 becomes a low-dispersion material with a too large Abbe number, it becomes difficult to correct chromatic aberration in the negative movable lens unit closest to the object, and it becomes difficult to suppress fluctuations in lateral chromatic aberration throughout the entire zoom range. In a case where νp2 becomes lower than the lower limit of inequality (11), the material of the second positive lens Lp2 becomes a high-dispersion material with a too small Abbe number. As a result, it becomes difficult to achieve both achromatism and aberration correction for the reference wavelength (d-line) in the negative movable lens unit closest to the object, and it becomes difficult to suppress spherical aberration particularly at the telephoto end.

In a case where θp2+0.00253×νp2 becomes higher than the upper limit of inequality (12), the partial dispersion ratio of the second positive lens Lp2 increases, the secondary spectrum of the lateral chromatic aberration is undercorrected, particularly at the wide-angle end. In a case where θp2+0.00253×νp2 becomes lower than the lower limit of inequality (12), the partial dispersion ratio of the second positive lens Lp2 reduces, and the secondary spectrum of the longitudinal chromatic aberration is overcorrected at the telephoto end.

Inequalities (9) to (12) may be replaced with inequalities (9a) to (12a) below:

$$62 \leq vn 2 \leq 90 \qquad ( 9 a )$$

$$0. \leq θ n 2 + 0.001 \times vn 2 - 0.603 \leq 0.03 \qquad ( 10 a )$$

$$20 \leq vp 2 \leq 30 \qquad ( 11 a )$$

$$0.655 \leq θ p 2 + 0.00253 \times vp 2 \leq 0.678 \qquad ( 12 a )$$

Inequalities (9) to (12) may be replaced with inequalities (9b) to (12b) below:

$$63 \leq vn 2 \leq 80 \qquad ( 9 b )$$

$$0.002 \leq θ n 2 + 0.001 \times vn 2 - 0.603 \leq 0.014 \qquad ( 10 b )$$

$$24 \leq vp 2 \leq 26 \qquad ( 11 b )$$

$$0.66 \leq θ p 2 + 0.00253 \times vp 2 \leq 0.677 \qquad ( 12 b )$$

The specific configurations of the zoom lenses according to Examples 1 to 6 will be described below:

### Examples 1 to 3

Each of the zoom lenses according to Examples 1 to 3 illustrated in FIGS. 1, 3 and 5 includes, in order from the object side to the image side, a first lens unit U1 with positive refractive power that does not move during zooming, a second lens unit U2 with negative refractive power, a third lens unit U3 with negative refractive power, and a fourth lens unit U4 with positive refractive power as movable lenses that move during zooming, and a fifth (final) lens unit U5 with positive refractive power for imaging that does not move during zooming.

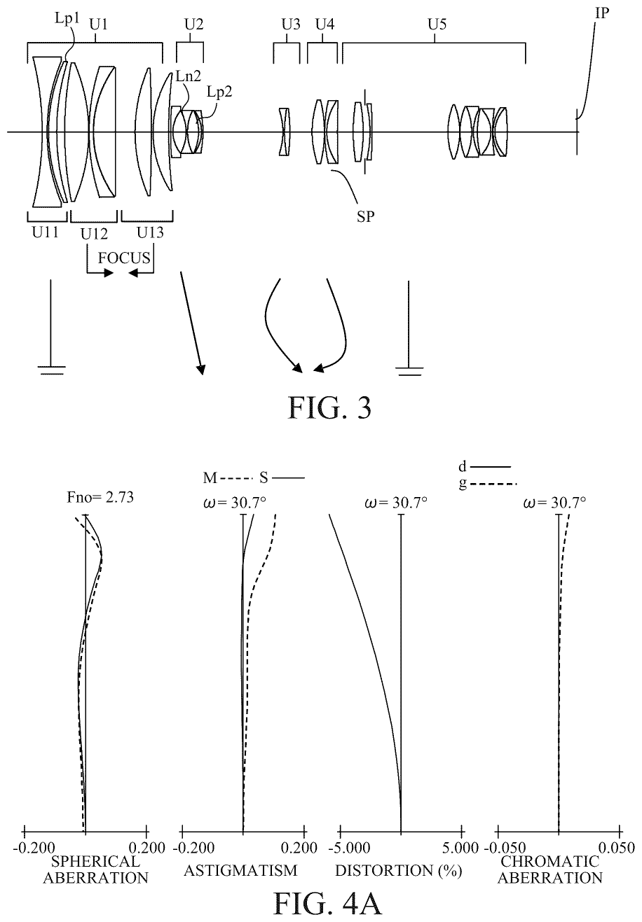

The first lens unit U1 in Examples 1 and 2 includes seven lenses, which include, in order from the object side to the image side, a first subunit U11 with negative refractive power, a second subunit U12 with positive refractive power and a third subunit U13 with positive refractive power. As indicated by the arrows in FIGS. 1 and 3, during focusing from infinity to a close distance, the first subunit U11 does not move, the second subunit U12 moves toward the image side, and the third subunit U13 moves toward the object side.

The first lens unit U1 in Example 3 includes nine lenses, which include, in order from the object side to the image side, a first subunit U11 with negative refractive power, a second subunit U12 with positive refractive power, and a third subunit U13 with positive refractive power. During focusing from infinity to a close distance, the first subunit U11 does not move, the second subunit U12 moves toward the image side, and the third subunit U13 does not move.

The second lens unit U2 in Examples 1 to 3 is a variator that moves toward the image side during zooming from the wide-angle end to the telephoto end, as indicated by the arrows in FIGS. 1, 3, and 5. The third lens unit U3 moves toward the object side and then moves toward the image side during zooming from the wide-angle end to the telephoto end. The fourth lens unit U4 moves toward the image side and then moves toward the object side during zooming from the wide-angle end to the telephoto end.

An aperture stop SP is disposed inside the fifth lens unit U5 in Examples 1 and 2. An aperture stop SP is disposed closest to the object in the fifth lens unit U5 in Example 3. An extender lens for focal length conversion or the like may be inserted or removed into and from the space inside the fifth lens unit U5 in Examples 1 to 3.

### Example 4

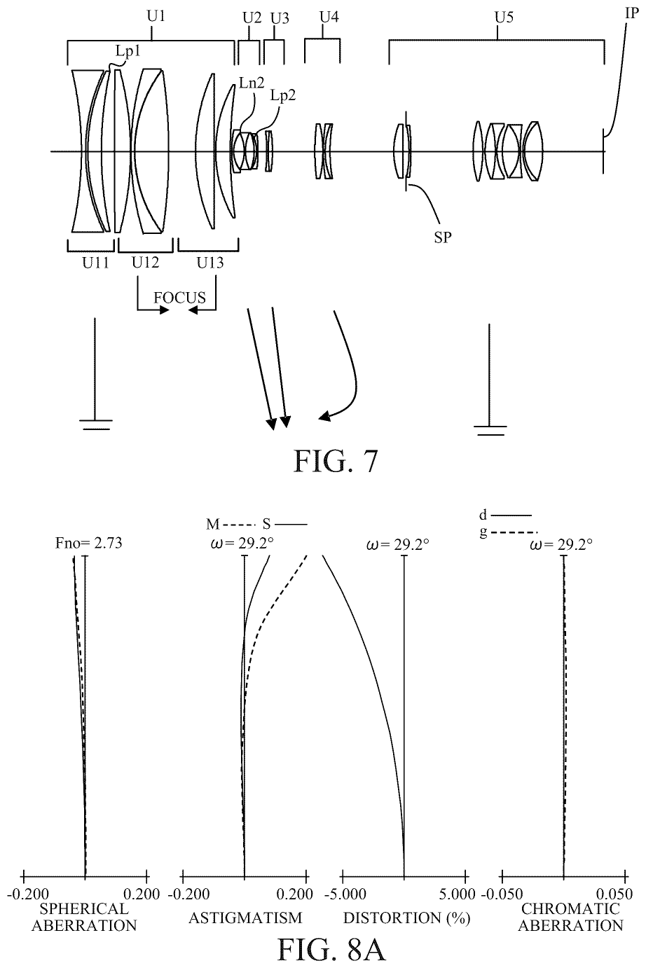

The zoom lens according to Example 4 illustrated in FIG. 7 includes, in order from the object side to the image side, a first lens unit U1 with positive refractive power that does not move during zooming, a second lens unit U2 with negative refractive power, a third lens unit U3 with positive refractive power, and a fourth lens unit U4 with positive refractive power as movable lenses that move during zooming, and a fifth (final) lens unit U5 with positive refractive power for imaging that does not move during zooming.

The first lens unit U1 includes seven lenses, which include, in order from the object side to the image side, a first subunit U11 with negative refractive power, a second subunit U12 with positive refractive power, and a third subunit U13 with positive refractive power. During focusing from infinity to a close distance, the first subunit U11 does not move, the second subunit U12 moves toward the image side, and the third subunit U13 moves toward the object side.

The second lens unit U2 is a variator that moves toward the image side during zooming from the wide-angle end to the telephoto end, as illustrated by the arrow in FIG. 7. The third lens unit U3 moves toward the image side during zooming from the wide-angle end to the telephoto end. The fourth lens unit U4 moves toward the image side and then toward the object side during zooming from the wide-angle end to the telephoto end.

An aperture stop SP is disposed inside the fifth lens unit U5. An extender lens for focal length conversion may be inserted or removed into the space inside the fifth lens unit U5.

### Example 5

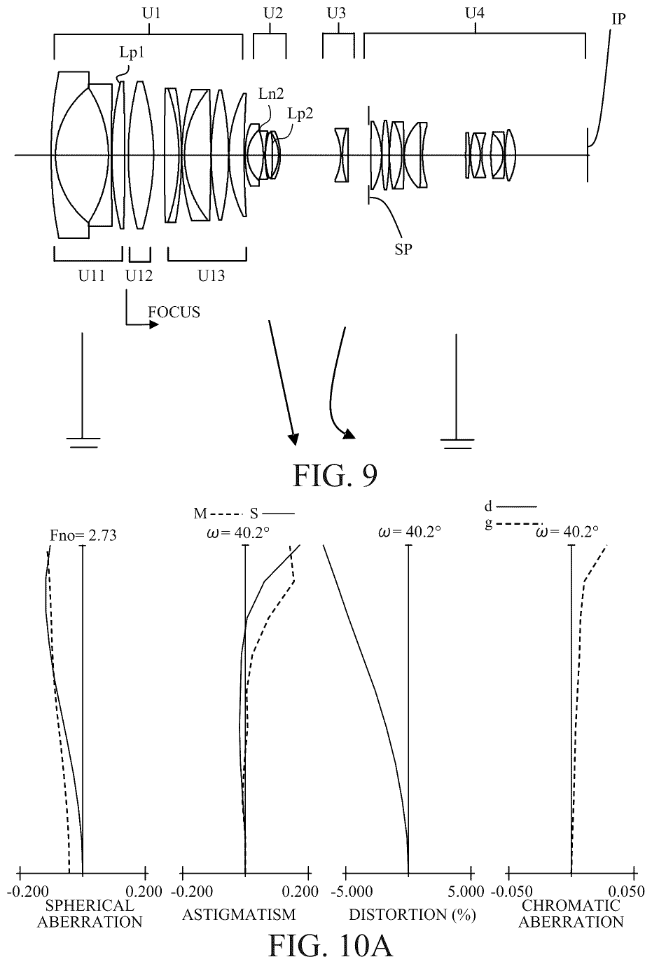

The zoom lens according to Example 5 illustrated in FIG. 9 includes, in order from the object side to the image side, a first lens unit U1 with positive refractive power that does not move during zooming, a second lens unit U2 with negative refractive power and a third lens unit U3 with negative refractive power that are movable lenses that move during zooming, and a fourth (final) lens unit U4 with positive refractive power for imaging that does not move during zooming.

The first lens unit U1 includes ten lenses, which include, in order from the object side to the image side, a first subunit U11 with negative refractive power, a second subunit U12 with positive refractive power, and a third subunit U13 with positive refractive power. During focusing from infinity to a close distance, the first subunit U11 does not move, the second subunit U12 moves toward the image side, and the third subunit U13 does not move.

The second lens unit U2 is a variator that moves toward the image side during zooming from the wide-angle end to the telephoto end, as illustrated by the arrow in FIG. 9. The third lens unit U3 moves toward the object side and then toward the image side during zooming from the wide-angle end to the telephoto end.

An aperture stop SP is disposed closest to the object of the fourth lens unit U4. An extender lens for focal length conversion or the like may be inserted or removed into the space within the fourth lens unit U4.

### Example 6

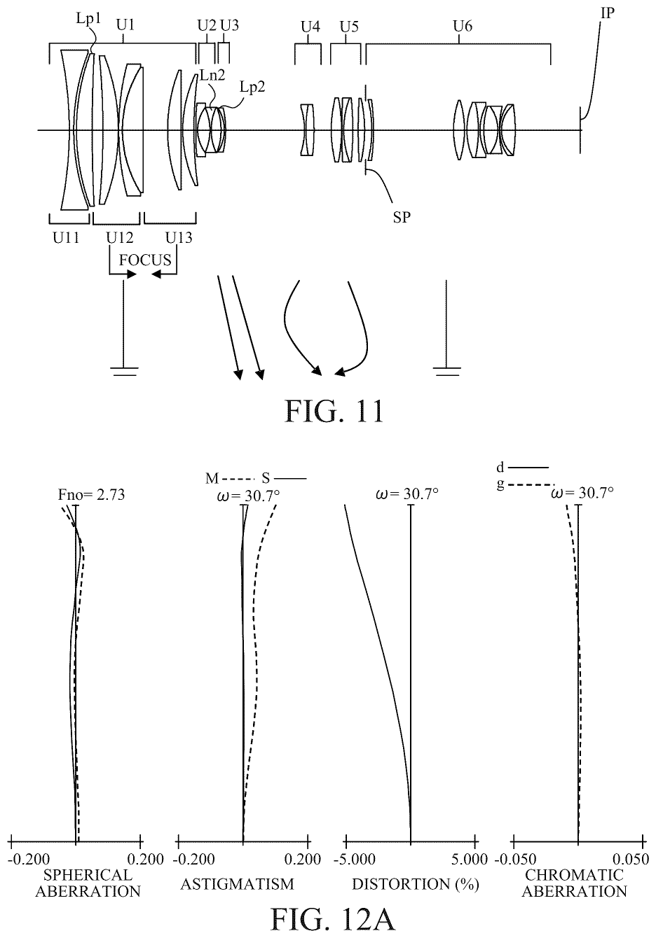

The zoom lens according to Example 6 illustrated in FIG. 11 includes, in order from the object side to the image side, a first lens unit U1 with positive refractive power that does not move during zooming, a second lens unit U2 with negative refractive power, a third lens unit U3 with negative refractive power, a fourth lens unit U4 with negative refractive power, and a fifth lens unit U5 with positive refractive power as movable lenses that move during zooming, and a sixth (final) lens unit U6 with positive refractive power for imaging that does not move during zooming.

The first lens unit U1 includes seven lenses, which include, in order from the object side to the image side, a first subunit U11 with negative refractive power, a second subunit U12 with positive refractive power, and a third subunit U13 with positive refractive power. During focusing from infinity to a close distance, the first subunit U11 does not move, the second subunit U12 moves toward the image side, and the third subunit U13 moves toward the object side.

The second lens unit U2 is a variator that moves toward the image side during zooming from the wide-angle end to the telephoto end, as illustrated by the arrow in FIG. 11. The third lens unit U3 moves toward the image side during zooming from the wide-angle end to the telephoto end. The fourth lens unit U4 moves toward the object side and then moves toward the image side during zooming from the wide-angle end to the telephoto end. The fifth lens unit U5 moves toward the image side and then moves toward the object side during zooming from the wide-angle end to the telephoto end.

An aperture stop SP is disposed closest to the object in the sixth lens unit U6. An extender lens for focal length conversion or the like may be inserted or removed into the space within the sixth lens unit U6.

Numerical examples 1 to 6 corresponding to Examples 1 to 6, respectively, will be illustrated below. In each numerical example, i represents the order of a surface counted from the object side, r represents a radius of curvature of an i-th surface, and d is a distance on the optical axis between i-th and (i+1)-th surfaces. nd and νd represent a refractive index for the d-line of an optical material between i-th and (i+1)-th surfaces, and an Abbe number based on the d-line, respectively. The Abbe number νd based on the d-line is expressed as:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer line.

The focal length, Fno (F-number), and half angle of view) (° are values in an in-focus state at infinity. BF represents the back focus (mm). “Back focus” is a distance on the optical axis from the final surface of a zoom lens (a lens surface closest to an image plane) to a paraxial image plane, expressed in air equivalent length. An “overall lens length” is a length on the optical axis from the frontmost surface of a zoom lens (a lens surface closest to the object) to the final surface, plus the back focus.

An asterisk “*” next to a surface number means that the surface has an aspheric shape. An aspheric shape is expressed by the following equation:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16}$$

where X is a displacement amount from a surface vertex in the optical axis direction, H is a height from the optical axis in a direction orthogonal to the optical axis, a light traveling direction is positive, R is a paraxial radius of curvature, K is a conic constant, and A4, A6, A8, A10, A12, A14, and A16 are aspheric coefficients. The “e-x” in the aspheric coefficient means ×10^{-x}.

Table 1 summarizes values of inequalities (1) to (12) in numerical examples 1 to 6. The zoom lenses in each numerical example satisfy all of inequalities (1) to (12).

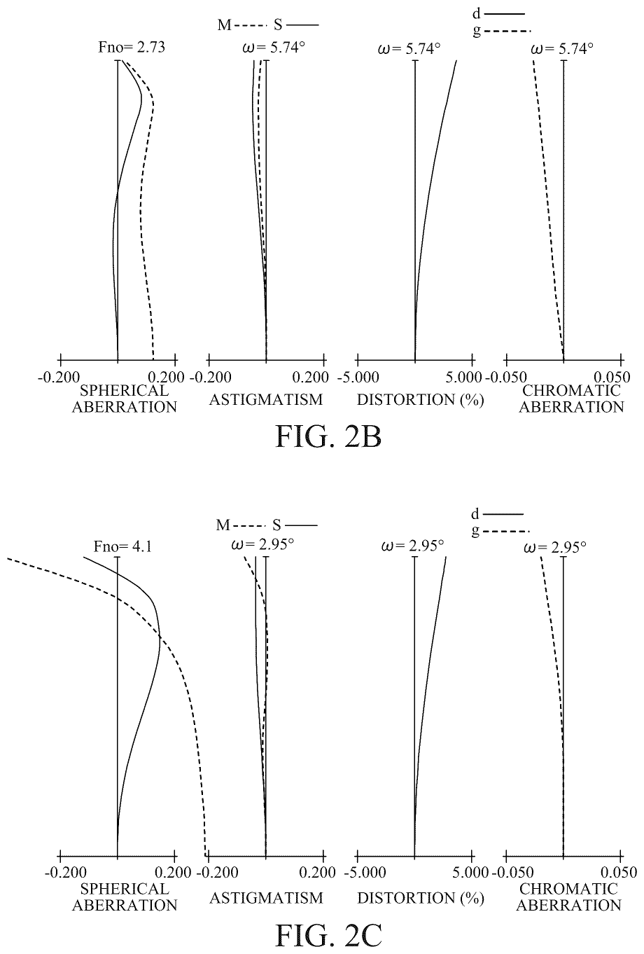

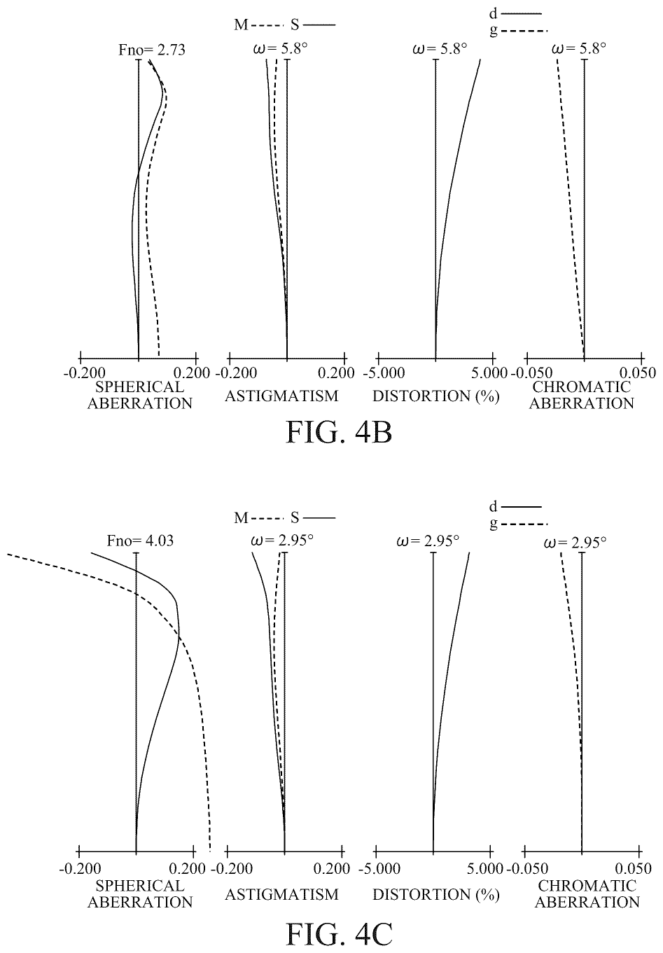

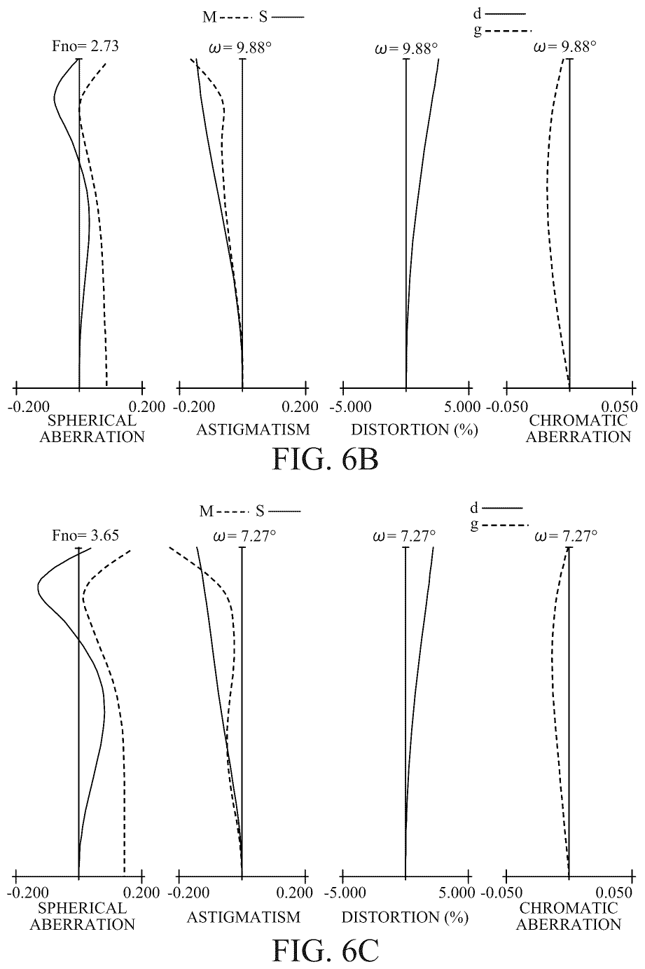

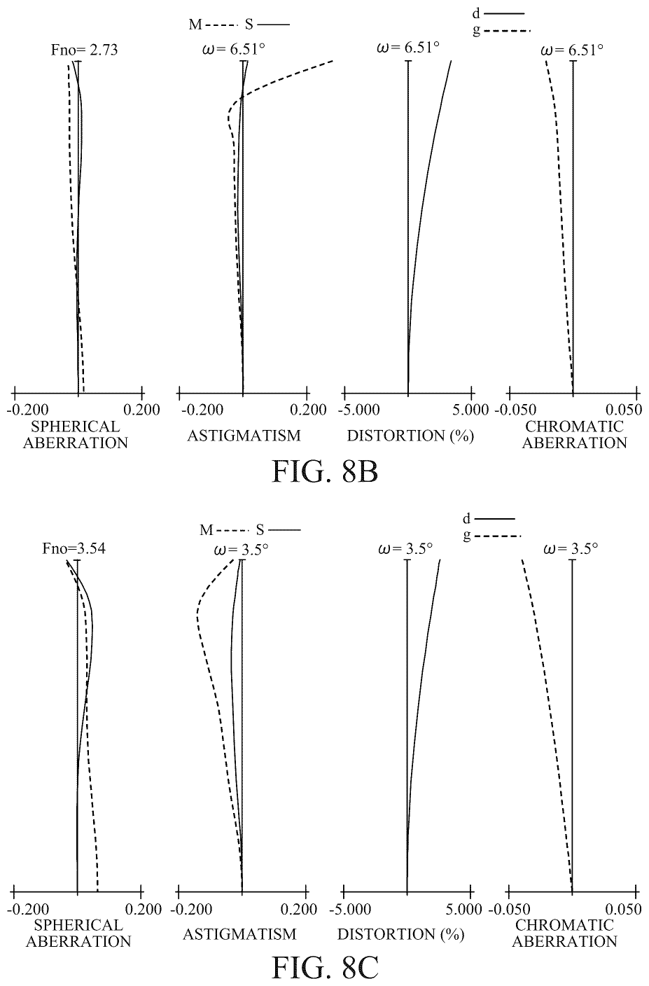

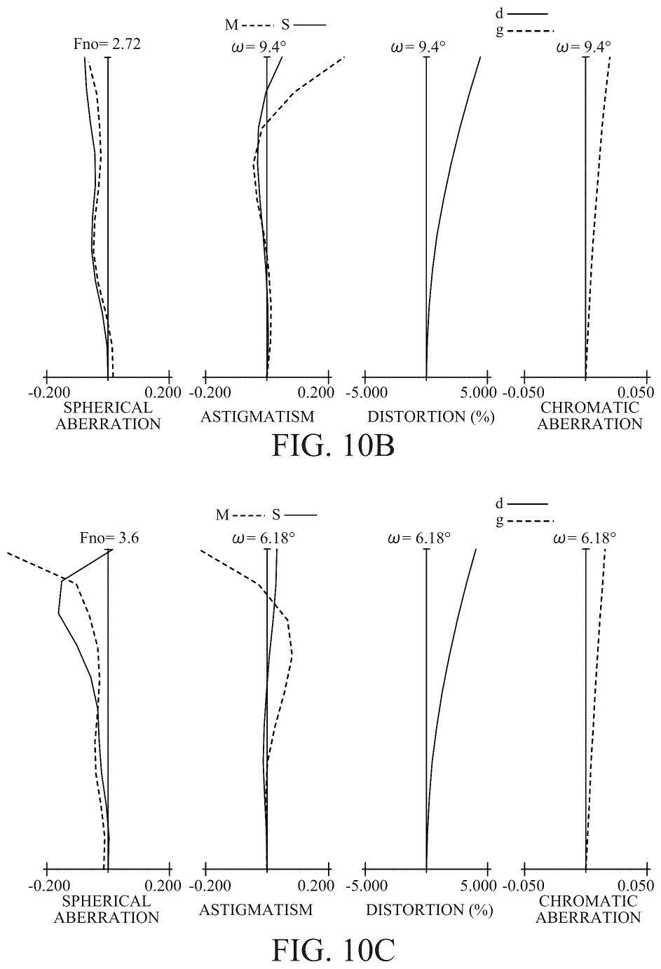

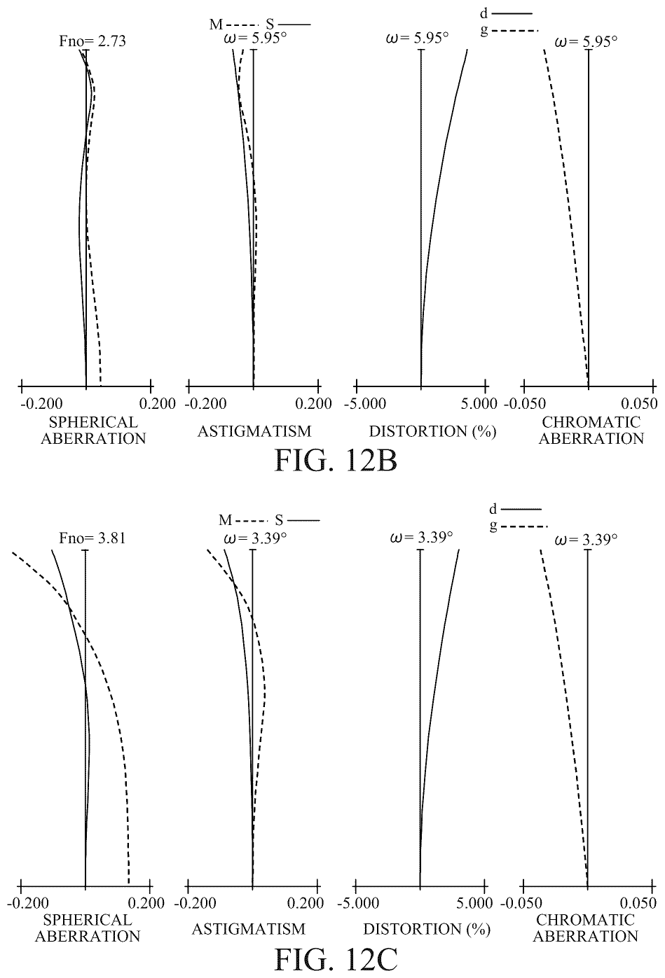

FIGS. 2A, 4A, 6A, 8A, 10A, and 12A respectively illustrate the longitudinal aberrations (spherical aberration, astigmatism, distortion, and chromatic aberration) of the zoom lenses according to numerical examples 1 to 6 in an in-focus state at infinity at a wide-angle end. FIGS. 2B, 4B, 6B, 8B, 10B, and 12B respectively illustrate the longitudinal aberrations of the zoom lenses according to numerical examples 1 to 6 in an in-focus state at infinity at an intermediate zoom position. FIGS. 2C, 4C, 6C, 8C, 10C, and 12C respectively illustrate the longitudinal aberrations of the zoom lenses according to numerical examples 1 to 6 in an in-focus state at infinity at a telephoto end.

In the spherical aberration diagram, Fno represents an F-number. A solid line indicates a spherical aberration amount for the d-line, and a dashed line indicates a spherical aberration amount for the g-line (wavelength 435.8 nm). In the astigmatism diagram, a solid line S indicates an astigmatism amount on a sagittal image plane, and a dashed line M indicates an astigmatism amount on a meridional image plane. The distortion diagram indicates a distortion amount for the d-line. The chromatic aberration diagram illustrates a lateral chromatic aberration amount for the g-line. ω represents a half angle of view (°).

In each numeral example, WIDE means a wide-angle end, MIDDLE means an intermediate zoom position, and TELE means a telephoto end.

### Numerical Example 1

UNIT: mm
SURFACE DATA

| Surface No. | r | d | nd | vd |
|---|---|---|---|---|
| 1 | −262.221 | 2.80 | 1.88300 | 40.8 |
| 2 | 136.383 | 0.83 | | |
| 3 | 125.967 | 5.07 | 1.98612 | 16.5 |
| 4 | 186.541 | 4.40 | | |
| 5 | 287.598 | 13.25 | 1.43875 | 94.7 |
| 6* | −131.259 | 0.20 | | |
| 7 | 152.530 | 2.40 | 1.85478 | 24.8 |
| 8 | 79.117 | 0.10 | | |
| 9 | 79.291 | 12.66 | 1.52841 | 76.5 |
| 10 | 16020.988 | 12.32 | | |
| 11 | 120.675 | 9.25 | 1.59522 | 67.7 |
| 12 | −1242.044 | 0.99 | | |
| 13 | 79.870 | 9.07 | 1.61800 | 63.3 |
| 14 | 394.020 | (Variable) | | |
| 15* | 937.239 | 1.20 | 2.00100 | 29.1 |
| 16 | 23.833 | 7.39 | | |
| 17 | −31.989 | 0.80 | 1.52841 | 76.5 |
| 18 | 33.447 | 6.30 | 1.85478 | 24.8 |
| 19 | −35.704 | 1.57 | | |
| 20 | −25.250 | 0.80 | 1.85150 | 40.8 |
| 21 | −98.722 | (Variable) | | |
| 22 | −52.270 | 0.90 | 1.88300 | 40.8 |
| 23 | 115.728 | 3.24 | 1.84666 | 23.8 |
| 24 | −131.697 | (Variable) | | |
| 25* | 75.874 | 7.07 | 1.76385 | 48.5 |
| 26 | −93.140 | 0.15 | | |
| 27 | 93.986 | 1.20 | 1.85478 | 24.8 |
| 28 | 40.250 | 5.98 | 1.59522 | 67.7 |
| 29 | 384.407 | (Variable) | | |
| 30 | 123.330 | 6.78 | 1.53775 | 74.7 |
| 31 | −75.958 | 1.00 | | |
| 32 (SP) | ∞ | 3.77 | | |
| 33 | −64.702 | 1.10 | 1.88300 | 40.8 |
| 34 | −621.569 | 43.69 | | |
| 35 | 63.004 | 6.86 | 1.48749 | 70.2 |
| 36 | −58.073 | 6.50 | | |
| 37 | 53.379 | 6.82 | 1.80810 | 22.8 |
| 38 | −41.160 | 1.00 | 2.00100 | 29.1 |
| 39 | 40.107 | 2.17 | | |
| 40 | 73.759 | 8.09 | 1.48749 | 70.2 |
| 41 | −23.016 | 1.00 | 1.88300 | 40.8 |
| 42 | 206.320 | 0.20 | | |
| 43 | 30.833 | 1.10 | 1.88300 | 40.8 |
| 44 | 23.095 | 8.53 | 1.51633 | 64.1 |
| 45 | −112.087 | (Variable) | | |
| Image Plane | ∞ | | | |

ASPHERIC DATA
6th Surface
K = −7.43182e−01 A 4 = −2.89706e−09 A 6 = −1.11754e−12 A 8 = 4.96240e−16
15th Surface
K = 1.90407e+00 A 4 = 5.34417e−06 A 6 = −3.53145e−09 A 8 = 2.39390e−11
A10 = −9.28133e−14 A12 = 2.17422e−16
25th Surface
K = 2.00007e+00 A 4 = −2.21894e−06 A 6 = 1.31120e−10 A 8 = −1.99758e−13

VARIOUS DATA
ZOOM RATIO 11.52

| | WIDE | MIDDLE | TELE |
|---|---|---|---|
| Focal Length | 24.94 | 147.25 | 287.17 |
| Fno | 2.73 | 2.73 | 4.10 |
| Half Angle of View (°) | 30.69 | 5.74 | 2.95 |
| Image Height | 14.80 | 14.80 | 14.80 |
| Overall Lens Length | 316.78 | 316.78 | 316.78 |
| BF | 40.00 | 40.00 | 40.00 |
| d14 | 1.13 | 48.57 | 55.04 |
| d21 | 49.56 | 3.30 | 2.23 |
| d24 | 9.44 | 14.95 | 1.15 |
| d29 | 8.10 | 1.41 | 9.81 |
| d45 | 40.00 | 40.00 | 40.00 |

LENS UNIT DATA

| Lens Unit | Starting Surface | Focal Length |
|---|---|---|
| 1 | 1 | 81.37 |
| 2 | 15 | −19.45 |
| 3 | 22 | −94.92 |
| 4 | 25 | 51.96 |
| 5 | 30 | 121.13 |

### Numerical Example 2

UNIT: mm
SURFACE DATA

| Surface No. | r | d | nd | vd |
|---|---|---|---|---|
| 1 | −222.510 | 2.80 | 1.83481 | 42.7 |
| 2 | 135.461 | 0.86 | | |
| 3 | 125.774 | 4.68 | 2.10420 | 17.0 |
| 4 | 174.042 | 4.52 | | |
| 5 | 266.403 | 13.84 | 1.43875 | 94.7 |
| 6* | −125.918 | 0.20 | | |
| 7 | 154.501 | 2.40 | 1.85478 | 24.8 |
| 8 | 79.852 | 0.10 | | |
| 9 | 80.012 | 12.58 | 1.52841 | 76.5 |
| 10 | 5722.539 | 11.37 | | |
| 11 | 119.682 | 9.28 | 1.59522 | 67.7 |
| 12 | −1282.377 | 0.99 | | |
| 13 | 79.728 | 9.04 | 1.61800 | 63.3 |
| 14 | 374.302 | (Variable) | | |
| 15* | 1483.600 | 1.20 | 2.00100 | 29.1 |
| 16 | 24.488 | 7.54 | | |
| 17 | −33.212 | 0.80 | 1.52841 | 76.5 |
| 18 | 34.824 | 6.35 | 1.85478 | 24.8 |
| 19 | −36.978 | 1.69 | | |
| 20 | −25.739 | 0.80 | 1.85150 | 40.8 |
| 21 | −88.739 | (Variable) | | |
| 22 | −50.625 | 0.90 | 1.88300 | 40.8 |
| 23 | 96.830 | 3.08 | 1.84666 | 23.8 |
| 24 | −138.820 | (Variable) | | |
| 25* | 67.696 | 7.08 | 1.76385 | 48.5 |
| 26 | −95.092 | 0.15 | | |
| 27 | 105.353 | 1.20 | 1.85478 | 24.8 |
| 28 | 39.840 | 6.03 | 1.59522 | 67.7 |
| 29 | 456.810 | (Variable) | | |
| 30 | 137.653 | 5.74 | 1.53775 | 74.7 |
| 31 | −121.385 | 1.00 | | |
| 32 (SP) | ∞ | 2.89 | | |
| 33 | −95.228 | 1.10 | 1.88300 | 40.8 |
| 34 | −443.742 | 43.67 | | |
| 35 | 54.129 | 6.78 | 1.48749 | 70.2 |
| 36 | −55.319 | 0.20 | | |
| 37 | 47.350 | 6.69 | 1.80810 | 22.8 |
| 38 | −47.081 | 1.00 | 2.00100 | 29.1 |
| 39 | 35.342 | 2.31 | | |
| 40 | 70.136 | 7.74 | 1.48749 | 70.2 |
| 41 | −23.162 | 1.00 | 1.88300 | 40.8 |
| 42 | 130.827 | 0.20 | | |
| 43 | 31.488 | 1.10 | 1.88300 | 40.8 |
| 44 | 23.902 | 7.05 | 1.51633 | 64.1 |
| 45 | −174.582 | (Variable) | | |
| Image Plane | ∞ | | | |

ASPHERIC DATA
6th Surface
K = −6.86455e−01 A 4 = −3.29932e−09 A 6 = −6.71576e−13 A 8 = 5.31527e−16
15th Surface
K = 2.00021e+00 A 4 = 5.29834e−06 A 6 = −3.12907e−09 A 8 = 1.80902e−11
A10 = −6.59395e−14 A12 = 1.53082e−16
25th Surface
K = 1.79114e+00 A 4 = −2.63811e−06 A 6 = 8.58692e−11 A 8 = −2.68690e−13

VARIOUS DATA
ZOOM RATIO 11.51

| | WIDE | MIDDLE | TELE |
|---|---|---|---|
| Focal Length | 24.94 | 145.66 | 287.15 |
| Fno | 2.73 | 2.73 | 4.03 |
| Half Angle of View (°) | 30.69 | 5.80 | 2.95 |
| Image Height | 14.80 | 14.80 | 14.80 |
| Overall Lens Length | 307.08 | 307.08 | 307.08 |
| BF | 40.00 | 40.00 | 40.00 |
| d14 | 1.20 | 48.44 | 54.88 |
| d21 | 45.98 | 3.23 | 2.19 |
| d24 | 12.81 | 15.57 | 1.13 |
| d29 | 9.10 | 1.85 | 10.89 |
| d45 | 40.00 | 40.00 | 40.00 |

LENS UNIT DATA

| Lens Unit | Starting Surface | Focal Length |
|---|---|---|
| 1 | 1 | 81.37 |
| 2 | 15 | −20.31 |
| 3 | 22 | −87.04 |
| 4 | 25 | 51.36 |
| 5 | 30 | 128.82 |

### Numerical Example 3

UNIT: mm
SURFACE DATA

| Surface No. | r | d | nd | vd |
|---|---|---|---|---|
| 1* | 1074.667 | 2.80 | 1.89190 | 37.1 |
| 2 | 43.685 | 27.00 | | |
| 3 | −75.730 | 2.20 | 1.62041 | 60.3 |
| 4 | −383.133 | 0.20 | | |
| 5 | 159.909 | 5.50 | 2.00000 | 13.8 |
| 6 | 588.066 | 1.20 | | |
| 7 | 214.936 | 12.31 | 1.59522 | 67.7 |
| 8* | −91.857 | 9.80 | | |
| 9 | 1347.924 | 9.09 | 1.67270 | 32.1 |
| 10 | −98.393 | 2.00 | 1.80810 | 22.8 |
| 11 | −283.387 | 0.20 | | |
| 12 | 220.290 | 2.00 | 1.80810 | 22.8 |
| 13 | 56.042 | 17.27 | 1.48749 | 70.2 |
| 14 | −156.232 | 0.20 | | |
| 15 | 106.333 | 10.64 | 1.75500 | 52.3 |
| 16 | −156.038 | (Variable) | | |
| 17* | 98.991 | 1.25 | 2.00100 | 29.1 |
| 18 | 22.833 | 7.34 | | |
| 19 | −35.043 | 0.90 | 1.52841 | 76.5 |
| 20 | 34.343 | 5.08 | 1.85478 | 24.8 |
| 21 | −72.398 | 3.46 | | |
| 22 | −24.031 | 1.00 | 1.85150 | 40.8 |
| 23 | −33.833 | (Variable) | | |
| 24 | −34.890 | 0.80 | 1.65160 | 58.5 |
| 25 | 77.193 | 2.52 | 1.80810 | 22.8 |
| 26 | 1302.716 | (Variable) | | |
| 27* | 69.685 | 5.67 | 1.89190 | 37.1 |
| 28 | −136.223 | (Variable) | | |
| 29 (SP) | ∞ | 1.35 | | |
| 30 | 44.026 | 7.79 | 1.48749 | 70.2 |
| 31 | −125.688 | 0.25 | | |
| 32 | 2346.338 | 1.20 | 2.00100 | 29.1 |
| 33 | 31.968 | 5.71 | 1.51633 | 64.1 |
| 34 | −18847.507 | 1.00 | | |
| 35 | −186.120 | 5.60 | 1.53172 | 48.8 |
| 36 | −32.247 | 1.10 | 1.88300 | 40.8 |
| 37 | −62.513 | 41.06 | | |
| 38 | 86.756 | 6.86 | 1.48749 | 70.2 |
| 39 | −52.385 | 2.04 | | |
| 40 | 42.959 | 8.71 | 1.80810 | 22.8 |
| 41 | −41.800 | 0.90 | 2.00100 | 29.1 |
| 42 | 30.823 | 1.30 | | |
| 43 | 27.833 | 10.81 | 1.43875 | 94.7 |
| 44 | −33.867 | 1.00 | 1.88300 | 40.8 |
| 45 | 68.068 | 0.50 | | |
| 46 | 42.446 | 6.64 | 1.48749 | 70.2 |
| 47 | −67.429 | (Variable) | | |
| Image Plane | ∞ | | | |

ASPHERIC DATA
1st Surface
K = 1.29203e+00 A 4 = 5.24187e−07 A 6 = 4.61325e−10 A 8 = −5.10222e−13
A10 = 2.62566e−16 A12 = −6.64497e−20 A14 = 5.01622e−24 A16 = 4.88118e−28
8th Surface
K = 2.00160e+00 A 4 = 1.02407e−06 A 6 = 1.11216e−10 A 8 = 2.34881e−15
A10 = −2.21128e−17 A12 = 8.84415e−21
17th Surface
K = 0.00000e+00 A 4 = 4.40622e−06 A 6 = −3.89061e−09 A 8 = 4.26997e−11
A10 = −3.46781e−13 A12 = 2.00503e−15 A14 = −6.39102e−18 A16 = 9.26900e−21
27th Surface
K = 0.00000e+00 A 4 = −2.05020e−06 A 6 = 8.77473e−10 A 8 = −9.04950e−13

VARIOUS DATA
ZOOM RATIO 7.69

| | WIDE | MIDDLE | TELE |
|---|---|---|---|
| Focal Length | 15.09 | 84.97 | 116.08 |
| Fno | 2.72 | 2.73 | 3.65 |
| Half Angle of View (°) | 44.45 | 9.88 | 7.27 |
| Image Height | 14.80 | 14.80 | 14.80 |
| Overall Lens Length | 339.07 | 339.07 | 339.07 |
| BF | 46.16 | 46.16 | 46.16 |
| d16 | 0.99 | 47.53 | 51.30 |
| d23 | 34.51 | 2.01 | 4.27 |
| d26 | 14.21 | 7.66 | 1.16 |
| d28 | 8.97 | 1.49 | 1.96 |
| d47 | 46.16 | 46.16 | 46.16 |

LENS UNIT DATA

| Lens Unit | Starting Surface | Focal Length |
|---|---|---|
| 1 | 1 | 43.85 |
| 2 | 17 | −26.48 |
| 3 | 24 | −57.90 |
| 4 | 27 | 52.37 |
| 5 | 29 | 89.82 |

### Numerical Example 4

UNIT: mm
SURFACE DATA

| Surface No. | r | d | nd | vd |
|---|---|---|---|---|
| 1 | −234.607 | 2.80 | 1.80000 | 29.8 |
| 2 | 123.876 | 1.48 | | |
| 3 | 123.657 | 8.98 | 1.98612 | 16.5 |
| 4 | 248.835 | 8.63 | | |
| 5 | 3015.789 | 10.91 | 1.43875 | 94.7 |
| 6* | −198.524 | 0.20 | | |
| 7 | 185.639 | 2.40 | 1.85478 | 24.8 |
| 8 | 89.418 | 0.12 | | |
| 9 | 89.526 | 22.57 | 1.59522 | 67.7 |
| 10 | −361.527 | 17.82 | | |
| 11 | 126.164 | 12.44 | 1.59522 | 67.7 |
| 12 | −66204.123 | 0.99 | | |
| 13 | 90.527 | 9.72 | 1.61800 | 63.3 |
| 14 | 299.858 | (Variable) | | |
| 15* | 101.155 | 1.20 | 2.00100 | 29.1 |
| 16 | 19.596 | 7.05 | | |
| 17 | −26.943 | 0.80 | 1.53775 | 74.7 |
| 18 | 29.174 | 5.79 | 1.85478 | 24.8 |
| 19 | −34.855 | 1.70 | | |
| 20 | −21.077 | 0.80 | 1.85150 | 40.8 |
| 21 | −95.436 | (Variable) | | |
| 22 | −101.598 | 0.90 | 1.89190 | 37.1 |
| 23 | 100.000 | 2.85 | 1.95375 | 32.3 |
| 24 | −100.000 | (Variable) | | |
| 25* | 139.476 | 5.44 | 1.76385 | 48.5 |
| 26 | −77.855 | 0.15 | | |
| 27 | 110.985 | 1.20 | 1.85478 | 24.8 |
| 28 | 46.272 | 3.31 | 1.59522 | 67.7 |
| 29 | 104.465 | (Variable) | | |
| 30 | 49.701 | 6.11 | 1.53775 | 74.7 |
| 31 | −1706.072 | 2.00 | | |
| 32 | ∞ | 2.13 | | |
| 33 | −82.892 | 1.10 | 1.88300 | 40.8 |
| 34 | −173.594 | 41.31 | | |
| 35 | 69.389 | 6.48 | 1.48749 | 70.2 |
| 36 | −76.960 | 1.62 | | |
| 37 | 47.766 | 6.85 | 1.80810 | 22.8 |
| 38 | −77.028 | 1.00 | 2.00100 | 29.1 |
| 39 | 32.182 | 3.59 | | |
| 40 | 41.879 | 10.98 | 1.48749 | 70.2 |
| 41 | −26.286 | 1.00 | 1.88300 | 40.8 |
| 42 | 135.907 | 1.64 | | |
| 43 | 34.805 | 1.10 | 1.88300 | 40.8 |
| 44 | 25.461 | 12.09 | 1.51633 | 64.1 |
| 45 | −57.644 | (Variable) | | |
| Image Plane | ∞ | | | |

ASPHERIC DATA
6th Surface
K = 1.87422e+00 A 4 = 6.06065e−08 A 6 = −5.94865e−13 A 8 = 2.77145e−16
15th Surface
K = 1.93424e+00 A 4 = 7.69049e−06 A 6 = −5.40926e−09 A 8 = 7.81922e−11
A10 = −3.67064e−13 A12 = 1.38416e−15
25th Surface
K = −1.06448e+00 A 4 = −6.38038e−07 A 6 = 2.88984e−10 A 8 = −1.48020e−13

VARIOUS DATA
ZOOM RATIO 9.13

| | WIDE | MIDDLE | TELE |
|---|---|---|---|
| Focal Length | 26.51 | 129.61 | 242.04 |
| Fno | 2.73 | 2.73 | 3.54 |
| Half Angle of View (°) | 29.17 | 6.51 | 3.50 |
| Image Height | 14.80 | 14.80 | 14.80 |
| Overall Lens Length | 347.11 | 347.11 | 347.11 |
| BF | 40.36 | 40.36 | 40.36 |
| d14 | 0.98 | 54.03 | 61.27 |
| d21 | 5.93 | 3.01 | 1.94 |
| d24 | 28.20 | 18.30 | 2.18 |
| d29 | 42.39 | 2.16 | 12.12 |
| d45 | 40.36 | 40.36 | 40.36 |

LENS UNIT DATA

| Lens Unit | Starting Surface | Focal Length |
|---|---|---|
| 1 | 1 | 89.20 |
| 2 | 15 | −15.87 |
| 3 | 22 | 652.19 |
| 4 | 25 | 83.64 |
| 5 | 30 | 83.03 |

### Numerical Example 5

UNIT: mm
SURFACE DATA

| Surface No. | r | d | nd | vd |
|---|---|---|---|---|
| 1* | 299.063 | 2.40 | 1.80100 | 35.0 |
| 2 | 47.242 | 29.22 | | |
| 3 | −68.809 | 1.80 | 1.64000 | 60.1 |
| 4 | 3277.662 | 0.18 | | |
| 5 | 174.767 | 7.08 | 1.97000 | 17.2 |
| 6 | −1403.793 | 1.99 | | |
| 7 | 166.263 | 13.96 | 1.59522 | 67.7 |
| 8* | −123.567 | 6.05 | | |
| 9 | 1467.907 | 7.95 | 1.49700 | 81.5 |
| 10 | −116.803 | 1.50 | 1.85478 | 24.8 |
| 11 | −209.556 | 0.18 | | |
| 12 | 124.190 | 1.50 | 1.84666 | 23.8 |
| 13 | 56.386 | 14.54 | 1.43875 | 94.9 |
| 14 | −890.919 | 0.20 | | |
| 15 | 151.623 | 9.63 | 1.49700 | 81.5 |
| 16 | −162.827 | 0.20 | | |
| 17 | 76.261 | 8.36 | 1.77250 | 49.6 |
| 18 | 500.978 | (Variable) | | |
| 19* | 66.238 | 1.30 | 1.77250 | 49.6 |
| 20 | 18.513 | 8.77 | | |
| 21 | −40.984 | 0.90 | 1.61800 | 63.3 |
| 22 | 59.872 | 0.20 | | |
| 23 | 40.922 | 3.90 | 1.85478 | 24.8 |
| 24 | −177.075 | 3.41 | | |
| 25 | −20.480 | 0.90 | 1.77250 | 49.6 |
| 26 | −30.520 | (Variable) | | |
| 27 | −31.035 | 0.90 | 1.72916 | 54.7 |
| 28 | 50.102 | 3.27 | 1.84666 | 23.8 |
| 29 | 1167.319 | (Variable) | | |
| 30 (SP) | ∞ | 1.29 | | |
| 31 | 781.806 | 5.86 | 1.69680 | 55.5 |
| 32 | −39.881 | 0.20 | | |
| 33 | 134.518 | 4.03 | 1.58913 | 61.1 |
| 34 | −122.542 | 0.20 | | |
| 35 | 99.184 | 6.78 | 1.51633 | 64.1 |
| 36 | −42.877 | 1.20 | 2.00100 | 29.1 |
| 37 | −515.005 | 0.20 | | |
| 38 | 24.881 | 8.90 | 1.53172 | 48.8 |
| 39 | −790.849 | 1.20 | 2.00069 | 25.5 |
| 40 | 56.714 | 23.87 | | |
| 41 | 317.045 | 2.04 | 1.48749 | 70.2 |
| 42 | −138.893 | 0.69 | | |
| 43 | 45.897 | 5.37 | 1.92286 | 18.9 |
| 44 | −26.794 | 0.80 | 1.95375 | 32.3 |
| 45 | 35.069 | 5.00 | | |
| 46 | 67.619 | 6.71 | 1.48749 | 70.2 |
| 47 | −15.476 | 0.90 | 2.00069 | 25.5 |
| 48 | −181.661 | 0.20 | | |
| 49 | 59.528 | 5.82 | 1.48749 | 70.2 |
| 50 | −30.623 | (Variable) | | |
| Image Plane | ∞ | | | |

ASPHERIC DATA
1st Surface
K = 2.08900e+00 A 4 = 1.47874e−07 A 6 = −2.01389e−10 A 8 = −9.65277e−14
A10 = −4.80338e−18 A12 = 1.26093e−21 A14 = −3.90133e−24 A16 = 1.61420e−27
A 5 = 6.71921e−09 A 7 = 2.89590e−12 A 9 = 1.02254e−15 A11 = 5.02702e−19
A13 = 9.11228e−23 A15 = −1.07211e−25
8th Surface
K = −1.64835e−01 A 4 = 3.85957e−07 A 6 = 1.36318e−10 A 8 = 7.63474e−14
A10 = 5.50955e−17 A12 = −1.14094e−19 A14 = 7.22772e−23 A16 = −5.03682e−26
A 5 = −6.61305e−10 A 7 = −8.86213e−12 A 9 = 3.44021e−15 A11 = −2.02141e−18
A13 = −2.61905e−22 A15 = 1.81827e−24
19th Surface
K = 5.74778e+00 A 4 = 4.06473e−06 A 6 = −1.48659e−09 A 8 = 1.63620e−09
A10 = 9.99256e−12 A12 = 8.21366e−14 A14 = 4.04250e−16 A16 = 1.44245e−19
A 5 = 1.30693e−07 A 7 = −8.16603e−09 A 9 = −1.54282e−10 A11 = −7.60139e−13
A13 = −7.35462e−15 A15 = −1.18718e−17

VARIOUS DATA
ZOOM RATIO 7.80

| | WIDE | MIDDLE | TELE |
|---|---|---|---|
| Focal Length | 17.53 | 89.43 | 136.77 |
| Fno | 2.73 | 2.72 | 3.60 |
| Half Angle of View (°) | 40.17 | 9.40 | 6.18 |
| Image Height | 14.80 | 14.80 | 14.80 |
| Overall Lens Length | 296.68 | 296.68 | 296.68 |
| BF | 39.78 | 39.78 | 39.78 |
| d18 | 0.62 | 35.42 | 39.75 |
| d26 | 33.49 | 2.31 | 4.80 |
| d29 | 11.25 | 7.64 | 0.82 |
| d50 | 39.78 | 39.78 | 39.78 |

LENS UNIT DATA

| Lens Unit | Starting Surface | Focal Length |
|---|---|---|
| 1 | 1 | 42.18 |
| 2 | 19 | −22.09 |
| 3 | 27 | −45.70 |
| 4 | 30 | 33.54 |

### Numerical Example 6

UNIT: mm
SURFACE DATA

| Surface No. | r | d | nd | vd |
|---|---|---|---|---|
| 1 | −246.005 | 2.80 | 2.00069 | 25.5 |
| 2 | 136.245 | 1.73 | | |
| 3 | 139.638 | 10.10 | 1.98612 | 16.5 |
| 4 | 995.648 | 6.87 | | |
| 5 | −494.694 | 9.89 | 1.49700 | 81.5 |
| 6* | −128.329 | 0.20 | | |
| 7 | 170.961 | 2.40 | 1.85478 | 24.8 |
| 8 | 75.289 | 0.00 | | |
| 9 | 75.289 | 13.22 | 1.61800 | 63.3 |
| 10 | −5634.563 | 15.66 | | |
| 11 | 107.022 | 8.66 | 1.61800 | 63.3 |
| 12 | −12144.069 | 1.00 | | |
| 13 | 83.339 | 7.10 | 1.60738 | 56.8 |
| 14 | 255.900 | (Variable) | | |
| 15* | 541.383 | 1.20 | 2.00100 | 29.1 |
| 16 | 24.442 | 7.80 | | |
| 17 | −34.564 | 0.80 | 1.53775 | 74.7 |
| 18 | 35.003 | 6.33 | 1.85478 | 24.8 |
| 19 | −41.232 | (Variable) | | |
| 20 | −26.291 | 0.80 | 1.85150 | 40.8 |
| 21 | −64.971 | (Variable) | | |
| 22 | −48.609 | 0.90 | 1.88300 | 40.8 |
| 23 | 86.503 | 5.25 | 1.84666 | 23.8 |
| 24 | −132.431 | (Variable) | | |
| 25* | 77.530 | 6.64 | 1.76385 | 48.5 |
| 26 | −105.305 | 0.15 | | |
| 27 | 423.721 | 1.20 | 1.85478 | 24.8 |
| 28 | 57.657 | 5.82 | 1.59522 | 67.7 |
| 29 | −207.164 | (Variable) | | |
| 30 | 379.906 | 4.01 | 1.53775 | 74.7 |
| 31 | −93.283 | 1.00 | | |
| 32 (SP) | ∞ | 3.64 | | |
| 33 | −82.075 | 1.10 | 1.88300 | 40.8 |
| 34 | −149.835 | 51.17 | | |
| 35 | 58.740 | 6.97 | 1.48749 | 70.2 |
| 36 | −65.662 | 1.59 | | |
| 37 | 45.594 | 7.38 | 1.80810 | 22.8 |
| 38 | −76.825 | 1.00 | 2.00100 | 29.1 |
| 39 | 33.739 | 2.41 | | |
| 40 | 49.804 | 8.98 | 1.48749 | 70.2 |
| 41 | −25.532 | 1.00 | 1.88300 | 40.8 |
| 42 | 66.673 | 0.20 | | |
| 43 | 28.565 | 1.10 | 1.88300 | 40.8 |
| 44 | 21.232 | 8.77 | 1.51633 | 64.1 |
| 45 | −106.834 | (Variable) | | |
| Image Plane | ∞ | | | |

ASPHERIC DATA
6th Surface
K = −9.97613e−01 A 4 = −4.09736e−08 A 6 = −4.86324e−12 A 8 = 4.88793e−16
15th Surface
K = −1.85176e+00 A 4 = 4.83789e−06 A 6 = −2.17941e−09 A 8 = 1.05210e−11
A10 = −3.73368e−14 A12 = 9.16654e−17
25th Surface
K = 2.00003e+00 A 4 = −2.23694e−06 A 6 = 1.74032e−10 A 8 = −1.78911e−13

VARIOUS DATA
ZOOM RATIO 10.03

| | WIDE | MIDDLE | TELE |
|---|---|---|---|
| Focal Length | 24.94 | 141.94 | 250.08 |
| Fno | 2.73 | 2.73 | 3.81 |
| Half Angle of View (°) | 30.69 | 5.95 | 3.39 |
| Image Height | 14.80 | 14.80 | 14.80 |
| Overall Lens Length | 326.63 | 326.63 | 326.63 |
| BF | 41.55 | 41.55 | 41.55 |
| d14 | 1.25 | 48.10 | 54.49 |
| d19 | 2.07 | 2.75 | 2.99 |
| d21 | 50.44 | 2.04 | 3.17 |
| d24 | 10.95 | 14.03 | 1.48 |
| d29 | 3.50 | 1.30 | 6.08 |
| d45 | 41.55 | 41.55 | 41.55 |

LENS UNIT DATA

| Lens Unit | Starting Surface | Focal Length |
|---|---|---|
| 1 | 1 | 82.18 |
| 2 | 15 | −61.55 |
| 3 | 20 | −52.36 |
| 4 | 22 | −84.73 |
| 5 | 25 | 58.55 |
| 6 | 30 | 111.88 |

TABLE 1

| | Numerical Example | | | | | |
|---|---|---|---|---|---|---|
| | 1 | 2 | 3 | 4 | 5 | 6 |
| (1) | 16.5 | 17.0 | 13.8 | 16.5 | 17.2 | 16.5 |
| (2) | 1.98612 | 2.10420 | 2.00000 | 1.98612 | 1.97000 | 1.98612 |
| (3) | 24.3 | 25.7 | 34.9 | 13.3 | 30.4 | 9.0 |
| (4) | −0.0041 | −0.0038 | −0.0039 | −0.0048 | −0.0032 | −0.0058 |
| (5) | 0.742 | 0.753 | 1.147 | 0.590 | 1.305 | 0.458 |
| (6) | −2.767 | −2.929 | −4.897 | −1.406 | −2.979 | −0.860 |
| (7) | 3.529 | 3.529 | 2.647 | 2.791 | 3.243 | 3.043 |
| (8) | 4.184 | 4.006 | 1.656 | 5.610 | 1.909 | 1.335 |
| (9) | 76.5 | 76.5 | 76.5 | 74.7 | 63.3 | 76.5 |
| (10) | 0.0131 | 0.0131 | 0.0131 | 0.0109 | 0.0029 | 0.0127 |
| (11) | 24.8 | 24.8 | 24.8 | 24.8 | 24.8 | 24.8 |
| (12) | 0.675 | 0.675 | 0.675 | 0.675 | 0.675 | 0.675 |
| νp1 | 16.5 | 17.0 | 13.8 | 16.5 | 17.2 | 16.5 |
| Np1 | 1.98612 | 2.10420 | 2.00000 | 1.98612 | 1.97000 | 1.98612 |
| νn1ₐᵥₑ | 40.8 | 42.7 | 48.7 | 29.8 | 47.55 | 25.5 |
| θn1ₐᵥₑ | 0.5667 | 0.5648 | 0.5604 | 0.6017 | 0.5617 | 0.6136 |
| θp1 | 0.6656 | 0.6631 | 0.6950 | 0.6656 | 0.6600 | 0.6656 |
| fn1 | −101.27 | −100.50 | −51.12 | −100.99 | −70.34 | −87.30 |
| fp1 | 377.70 | 390.84 | 218.23 | 240.70 | 160.58 | 163.74 |
| f11 | −136.52 | −133.42 | −44.56 | −171.16 | −53.90 | −190.50 |
| f1 | 81.37 | 81.37 | 43.85 | 89.03 | 42.18 | 82.18 |
| ft | 287.17 | 287.15 | 116.08 | 248.45 | 136.77 | 250.08 |
| f2 | −19.45 | −20.31 | −26.48 | −15.87 | −22.09 | −61.55 |
| νn2 | 76.5 | 76.5 | 76.5 | 74.7 | 63.32 | 76.5 |
| θn2 | 0.5396 | 0.5396 | 0.5396 | 0.5392 | 0.5426 | 0.5392 |
| νp2 | 24.8 | 24.8 | 24.8 | 24.8 | 24.8 | 24.8 |
| θp2 | 0.6122 | 0.6122 | 0.6122 | 0.6122 | 0.6122 | 0.6122 |

### Image Pickup Apparatus

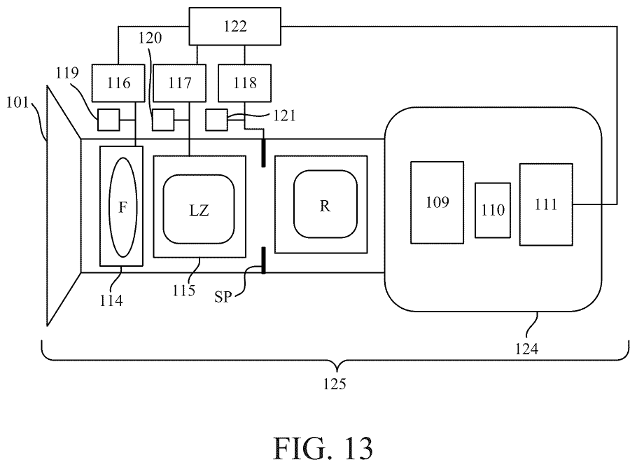

FIG. 13 illustrates an image pickup apparatus (broadcasting camera) that uses a zoom lens according to any one of Examples 1 to 6 as an imaging optical system. Reference numeral 101 denotes one of the zoom lenses according to Examples 1 to 6. Reference numeral 124 denotes a camera body. The zoom lens 101 is attachable to and detachable from the camera body 124. Reference numeral 125 denotes an image pickup apparatus that is configured by attaching the zoom lens 101 to the camera body 124.

The zoom lens 101 includes a first lens unit F, a magnification varying unit LZ, and an R lens unit R for imaging. The first lens unit F includes a subunit that moves during focusing. The magnification varying unit LZ includes at least two movable lens units that move during zooming. SP represents an aperture stop (diaphragm). Reference numerals 114 and 115 denote drive mechanisms such as helicoids and cams that drive the first lens unit F and the magnification varying unit LZ in the optical axis direction, respectively. Reference numerals 116 to 118 denote motors that electrically drive the drive mechanisms 114 and 115 and the aperture stop SP. Reference numerals 119 to 121 denote detectors such as encoders, potentiometers, and photosensors for detecting the positions on the optical axis of the first lens unit F and the magnification varying unit LZ and the aperture diameter in the aperture stop SP.

In the camera body 124, reference numeral 109 denotes a glass block equivalent to an optical filter in the camera body 124, and reference numeral 110 denotes an image sensor such as a CCD sensor or CMOS sensor that photoelectrically converts an object image formed by the zoom lens 101 (imaging an object). Reference numerals 111 and 122 denote control units such as a CPU that controls the various drives of the camera body 124 and the zoom lens 101.

By using the zoom lens according to each example as the imaging optical system in this way, an image pickup apparatus can have high optical performance. The image pickup apparatus may be a lens interchangeable type camera or a lens integrated type camera, and may be a single-lens reflex camera having a quick-return mirror or a mirrorless camera not having a quick-return mirror.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a zoom lens that has a reduced size, a wide angle of view, a high magnification variation ratio, and high optical performance over the entire zoom range.

This application claims priority to Japanese Patent Application No. 2024-024017, which was filed on Feb. 20, 2024, hereby incorporated by reference herein in its entirety.

What is claimed is:

1. A zoom lens comprising, in order from an object side to an image side:
a first lens unit with positive refractive power that does not move during zooming;
at least two movable lens units that move during zooming; and
a final lens unit with positive refractive power that does not move during zooming,
wherein a distance between adjacent lens units changes during zooming,
wherein the first lens unit includes at least one negative lens and at least one positive lens, and
wherein the following inequality is satisfied:
$$10. \leq vp 1 \leq 17.4$$
where νp1 is an Abbe number based on d-line of a first positive lens included in the at least one positive lens.

2. The zoom lens according to claim 1, wherein the following inequality is satisfied:
$$1.95 \leq Np 1 \leq 2.35$$
where Np1 is a refractive index of the first positive lens for the d-line.

3. The zoom lens according to claim 1, wherein the first lens unit includes, in order from the object side to the image side, a first subunit with negative refractive power, a second subunit with positive refractive power, and a third subunit with positive refractive power, and
wherein during focusing, the first subunit does not move, and at least the second subunit among the second subunit and the third subunit moves.

4. The zoom lens according to claim 3, wherein the first positive lens is included in the first subunit.

5. The zoom lens according to claim 3, wherein the first subunit includes at least one negative lens, and
wherein the following inequalities are satisfied:
$$5 \leq vn {1}_{ave} - vp 1 \leq 40$$
$$- 0.0065 \leq ( θ n {1}_{ave} - θ p 1 ) / ( vn {1}_{ave} - vp 1 ) \leq - 0.0025$$
where vn1ₐᵥₑ is an average Abbe number based on the d-line of the negative lens in the first subunit, θn1ₐᵥₑ is an average partial dispersion ratio for g-line and F-line of the negative lens in the first subunit, and θp1 is a partial dispersion ratio for the g-line and the F-line of the first positive lens.

6. The zoom lens according to claim 3, wherein the first subunit includes at least one negative lens, and
wherein the following inequality is satisfied:
$$0.4 \leq fn 1 / f 11 \leq 2.$$
where fn1 is a focal length of a negative lens closest to an object among the at least one negative lens of the first subunit, and f11 is a focal length of the first subunit.

7. The zoom lens according to claim 3, wherein the first subunit includes at least one negative lens, and
wherein the following inequality is satisfied:
$$- 6. \leq fp 1 / f 11 \leq - 0.6$$
where fm1 is a focal length of a negative lens closest to an object among the at least one negative lens of the first subunit, and f11 is a focal length of the first subunit.

8. The zoom lens according to claim 1, wherein the following inequality is satisfied:
$$2.5 \leq ft / f 1 \leq 5.$$
where f1 is a focal length of the first lens unit, and ft is a focal length of the zoom lens at a telephoto end.

9. The zoom lens according to claim 1, wherein at least one of the at least two movable lens units has negative refractive power, and
wherein the following inequality is satisfied:
$$1. \leq \vert f 1 / f 2 \vert \leq 6.$$
where f1 is a focal length of the first lens unit, and f2 is a focal length of a movable lens unit closest to an object among the at least one movable lens unit having negative refractive power.

10. The zoom lens according to claim 1, wherein at least one of the at least two movable lens units has negative refractive power,
wherein a movable lens unit closest to an object of the at least one movable lens unit with negative refractive power includes a negative lens, and
wherein the following inequalities are satisfied:
$$60 \leq vn 2 \leq 105$$
$$- 0.002 \leq θ n 2 + 0.001 \times vn 2 - 0.603 \leq 0.05$$
where vn2 is an Abbe number based on the d-line of the negative lens closest to the object of the movable lens unit, and θn2 is a partial dispersion ratio for g-line and F-line of the negative lens closest to the object of the movable lens unit.

11. The zoom lens according to claim 1, wherein at least one of the at least two movable lens units has negative refractive power,
wherein a movable lens unit closest to an object of the at least one movable lens unit with negative refractive power includes a second positive lens, and
wherein the following inequalities are satisfied:
$$20 \leq vp 2 \leq 40$$
$$0.648 \leq θ p 2 + 0.00253 \times vp 2 \leq 0.68$$
where νp2 is an Abbe number based on the d-line of the second positive lens, and θp2 is a dispersion ratio for g-line and F-line of the second positive lens.

12. An image pickup apparatus comprising:
a zoom lens, and
an image sensor configured to image an object through the zoom lens,
wherein the zoom lens includes, in order from an object side to an image side:
a first lens unit with positive refractive power that does not move during zooming;
at least two movable lens units that move during zooming; and
a final lens unit with positive refractive power that does not move during zooming,
wherein a distance between adjacent lens units changes during zooming,
wherein the first lens unit includes at least one negative lens and at least one positive lens, and
wherein the following inequality is satisfied:
$$10. \leq vp 1 \leq 17.4$$
where νp1 is an Abbe number based on d-line of a first positive lens included in the at least one positive lens.
